(19) United States
(12) Patent Application Publication
(10) Pub. No.: US 2023/0312809 A1
(43) Pub. Date: Oct. 5, 2023

(54) LIQUID FORMULATION COMPRISING AN ALDEHYDE SCAVENGER

(71) Applicant: REPI S.R.L., Lonate Ceppino (IT)

(72) Inventors: Paolo BANFI, Gallarate (IT); Sandra MARELLI, Cairate (IT); Michele PULICI, Azzate (IT); Silvia SOTTOCORNOLA, Oltrona di S. Mamette (IT)

(21) Appl. No.: 17/927,496

(22) PCT Filed: May 21, 2021
(86) PCT No.: PCT/EP2021/063706

§ 371 Date: Nov. 23, 2022

(30) Foreign Application Priority Data
May 26, 2020 (IT) 102020000012334

(51) Int. Cl. C08G 18/48; C08K 5/18; C08K 5/17; C08K 5/24; C08G 18/08

(52) U.S. Cl. CPC C08G 18/4825; C08G 18/0838; C08K 5/17; C08K 5/18; C08K 5/24

(57) ABSTRACT

A liquid formulation including a polyol, a polymeric plasticizer, and a scavenger of volatile aldehydes, such as acetaldehyde and formaldehyde, where the scavenger is selected from the group of compounds as-recited herein. Furthermore, a method for preparing the liquid formulation is related and a method for preparing a polyurethane composition, characterized by a reduced content of free aldehydes, the method including the step of adding the liquid formulation according to the reagents of the polyurethane composition.

### TECHNICAL FIELD

The present disclosure relates to a liquid formulation comprising a scavenger of volatile aldehydes such as, for example, acetaldehyde and formaldehyde. Such formulation is particularly, but not exclusively, useful for manufacturing polyurethane compositions.

### BACKGROUND

During the synthesis of polyurethane, some side reactions take place which can lead to the formation and release of aldehydes, in particular acetaldehyde and formaldehyde. These aldehydes are formed in sufficient quantities to be detectable by their odor inside, for example, the passenger compartments of cars, where there are usually components made of polyurethane, for example in the form of flexible foam modeled for seats or semirigid/rigid foam for steering wheels and other accessory components.

The presence of volatile aldehydes can be correlated to phenomena of toxicity. The International Agency for Research on Cancer (IARC) has in fact reported carcinogenic effects of formaldehyde in experimental studies that show a possible dose/response relationship; the presence of formaldehyde has furthermore been positively associated with nasal sinus cancer. Formaldehyde and acetaldehyde are therefore classified by the IARC as compounds in group I (carcinogenic). Therefore, a level of exposure as low as possible is recommended.

The presence of these aldehydes can further give rise to intolerance problems, particularly in Asiatic populations, who are deficient in the aldehyde dehydrogenase 2 enzyme. In particular, the presence of aldehydes, such as acetaldehyde and formaldehyde, may have a role in the pathogenesis of asthma in these populations, through two metabolic pathways. Firstly, the increase in the levels of acetaldehyde in the blood owing to the aforementioned genetic deficiency of aldehyde dehydrogenase 2 activity in some Asiatic populations stimulates the mast cells to release histamine after taking alcohol orally and this causes bronchoconstriction. Furthermore, inhaled acetaldehyde can act as an endocrine disruptor (EDC) and increase inflammatory processes of an allergic nature (Respiration 2012; 84:135-141). In fact, acetaldehyde is a volatile organic compound (VOC) and is known to belong to the category of “endocrine disruptors”, substances that alter the normal hormonal functionality of the endocrine apparatus, causing adverse effects on the health of an organism, of its progeny or of a population or subpopulation thereof (European Workshop on the impact of endocrine disruptors on human health and wildlife, 2-4 December, 1996, Weybridge).

It is known that in systems that are completely different from polyurethane systems, amines and derivatives thereof are used to abate acetaldehyde for example in polyesters, in particular in PET (see for example WO2010094947 or WO2007072067), while the formaldehyde that is intentionally used in the tanning of hides is, for example, abated with phenolic derivatives. In the wood industry, treatments are known for reducing formaldehyde emissions from finished products by treatment with scavengers such as ammonia, oxygenated sulfur compounds and organic amines (“Effects of post-manufacture board treatments on formaldehyde emission: a literature review (1960-1984)”, George E. Myers, FOREST PRODUCTS JOURNAL, Vol. 36, No. 6).

Currently, no industrial solutions exist for limiting the amount of free aldehydes in common polyurethane foams, apart from a careful selection of the raw materials used, for example, by automobile makers. In fact, both polyols and isocyanates, used in the production of polyurethane foams, can contain free aldehydes, generated by secondary reactions in the synthesis thereof. Furthermore, free aldehydes are also generated in the synthesis of polyurethane. The selection of materials therefore tends toward raw materials with a lower content of free aldehydes and/or raw materials that empirically generate smaller quantities of free formaldehyde and free acetaldehyde during the production of polyurethane. However, the aforesaid raw materials with a lower content of free aldehydes are generally more expensive.

Besides, the use of additives to abate the content of free aldehydes in polyurethanes has been found to be problematic. In fact, it is known that the use of further additives, in addition to the additives already commonly used in polyol-isocyanate systems, such as for example catalysts, blowing agents, cross-linkers, silicone surfactants and others, can cause defects in the final polyurethane foam, for example the accretion of bubbles during polymerization or nucleation defects.

### SUMMARY

In light of the above limitations of the prior art, the aim of the present disclosure is to provide a formulation that is effective in reducing levels of free aldehydes, such as, for example, acetaldehyde or formaldehyde, in polyurethane polymeric compounds.

Within this aim, the disclosure provides a process for preparing the above mentioned formulation that is economic and easy to carry out.

The present disclosure also provides a method with which to provide polyurethane polymeric compositions that are characterized by a reduced level of free aldehydes.

This aim and these and other advantages which will become better apparent hereinafter are achieved by providing a liquid formulation for reducing the free aldehydes levels in a polyurethane composition, said formulation comprising a polyol, a polymeric plasticizer, and an aldehyde scavenger selected from the group consisting of anthranilamide, salicylamide, salicylanilide, o-phenylenediamine, 3,4-diaminobenzoic acid, 1,8-diaminonaphthalene, o-mercaptobenzamide, N-acetylglycinamide, malonamide, 3-mercapto-1,2-propanediol, 4-amino-3-hydroxybenzoic acid, 4,5-dihydroxy-2,7-naphthalenedisulfonic acid disodium salt, biuret, 2,3-diaminopyridine, 1,2-diaminoanthraquinone, dianilinoethane, allantoin, 2-aminobenzenesulfonamide, 2-amino-2-methyl-1,3-propanediol, 6-amino-1,3-dimethyluracil, 6-aminoisocytosine, 6-aminouracil, 6-amino-1-methyluracil, urea, arginine salts, cysteine salts, serine salts, glycine salts, aminoguanidine salts, aspartic acid, guanidine salts, hydrazine, p-toluenesulfonyl hydrazine, carbohydrazide, oxalyldihydrazide, adipic acid dihydrazide, succinyldihydrazide, tocopherol, resveratrol, p-aminobenzoic acid, 3,5-dihydroxybenzoic acid, 4-hydroxybenzoic acid, mannitol, sorbitol, 5-aminolevulinic acid, methyl anthranilate, m-xylenediamine, 1,2-diaminocyclohexane and mixtures thereof.

The aim and the advantages of the present disclosure are also achieved by a method for preparing the formulation according to the disclosure, which comprises the steps of:
i) mixing a polyol, a polymeric plasticizer, and the aldehyde scavenger described above, until a homogeneous liquid dispersion is obtained;
ii) milling the homogeneous liquid dispersion of step i) until obtainment of an average size of the solid particles dispersed in the homogeneous liquid dispersion of less than 50 µm, preferably less than 30 µm, as measured by means of a grindometer according to the ASTM D1210-05 standard.

Furthermore, the aim and the advantages of the disclosure are also achieved by providing a method for preparing a polyurethane composition comprising the step of adding the liquid formulation according to the disclosure to the reagents of the polyurethane composition.

### DETAILED DESCRIPTION OF THE DISCLOSURE

Further characteristics and advantages of the disclosure will become better apparent from the detailed description that follows.

In a first aspect, the present disclosure relates to a liquid formulation for reducing free aldehydes levels in a polyurethane composition, said formulation comprising a polyol, a polymeric plasticizer, and an aldehyde scavenger selected from the group consisting of anthranilamide, salicylamide, salicylanilide, o-phenylenediamine, 3,4-diaminobenzoic acid, 1,8-diaminonaphthalene, o-mercaptobenzamide, N-acetylglycinamide, malonamide, 3-mercapto-1,2-propanediol, 4-amino-3-hydroxybenzoic acid, 4,5-dihydroxy-2,7-naphthalenedisulfonic acid disodium salt, biuret, 2,3-diaminopyridine, 1,2-diaminoanthraquinone, dianilinoethane, allantoin, 2-aminobenzenesulfonamide, 2-amino-2-methyl-1,3-propanediol, 6-amino-1,3-dimethyluracil, 6-aminoisocytosine, 6-aminouracil, 6-amino-1-methyluracil, urea, arginine salts, cysteine salts, serine salts, glycine salts, aminoguanidine salts, aspartic acid, guanidine salts, hydrazine, p-toluenesulfonyl hydrazine, carbohydrazide, oxalyldihydrazide, adipic acid dihydrazide, succinyldihydrazide, tocopherol, resveratrol, p-aminobenzoic acid, 3,5-dihydroxybenzoic acid, 4-hydroxybenzoic acid, mannitol, sorbitol, 5-aminolevulinic acid, methyl anthranilate, m-xylenediamine, 1,2-diaminocyclohexane and mixtures thereof.

As noted above, a first component of the composition according to the disclosure is represented by a polyol.

In a preferred embodiment the polyol is polypropylene glycol.

In a preferred embodiment, the formulation of the disclosure comprises polypropylene glycol in an amount of 10%-70% by weight, preferably 30%-to 50% by weight, even more preferably 37% by weight, of the total weight of the formulation.

The formulation according to the disclosure further comprises at least one polymeric plasticizer.

Plasticizers are substances that are added to a polymeric material to increase their deformability, flexibility, elongation and mechanical strength at low temperatures.

Such effects are due to the molecules of the plasticizers, which are much smaller than the macromolecules of the polymers and therefore infiltrate between the macromolecules (the small molecules surround the macromolecules), increasing their mobility. The more the macromolecules are surrounded by these small molecules, the more they can respond freely to an external stress. There are several classes of polymeric plasticizers on the market, of which non-limiting examples suitable for use in the formulation according to the disclosure are represented by adipic acid esters, phthalic esters, benzoic acid esters, citrate esters, alkyl sulfonates or products based on sebacic acid or cyclohexanedicarboxylic acid.

In a preferred embodiment, the formulation according to the disclosure comprises the polymeric plasticizer in an amount of 10% to 60% by weight, preferably 20% to 35% by weight, even more preferably 24% by weight, of the total weight of the formulation.

In a preferred embodiment of the formulation according to the disclosure, the polymeric plasticizer is an adipic acid ester.

Non-limiting examples of an adipic acid ester that are sold as a polymeric plasticizer are the products known by the trade names Radichem® Ester MA (RadiciGroup), Plaxter® P54 (COIM) and Palamoll® 652 (BASF).

In another preferred embodiment of the formulation according to the disclosure, the weight ratio between the polyol and the polymeric plasticizer is comprised between 80:20 and 50:50.

In a preferred embodiment of the formulation according to the disclosure, the weight ratio between the polyol and the polymeric plasticizer is 60:40.

The formulation according to the disclosure further comprises an aldehyde scavenger, such as, for example, acetaldehyde or formaldehyde, selected from the group consisting of anthranilamide, salicylamide, salicylanilide, o-phenylenediamine, 3,4-diaminobenzoic acid, 1,8-diaminonaphthalene, o-mercaptobenzamide, N-acetylglycinamide, malonamide, 3-mercapto-1,2-propanediol, 4-amino-3-hydroxybenzoic acid, 4,5-dihydroxy-2,7-naphthalenedisulfonic acid disodium salt, biuret, 2,3-diaminopyridine, 1,2-diaminoanthraquinone, dianilinoethane, allantoin, 2-aminobenzenesulfonamide, 2-amino-2-methyl-1,3-propanediol, 6-amino-1,3-dimethyluracil, 6-aminoisocytosine, 6-aminouracil, 6-amino-1-methyluracil, urea, arginine salts, cysteine salts, serine salts, glycine salts, aminoguanidine salts, aspartic acid, guanidine salts, hydrazine, p-toluenesulfonyl hydrazine, carbohydrazide, oxalyldihydrazide, adipic acid dihydrazide, succinyldihydrazide, tocopherol, resveratrol, p-aminobenzoic acid, 3,5-dihydroxybenzoic acid, 4-hydroxybenzoic acid, mannitol, sorbitol, 5-aminolevulinic acid, methyl anthranilate, m-xylenediamine, 1,2-diaminocyclohexane and mixtures thereof.

In a preferred embodiment, the formulation according to the disclosure comprises the aldehyde scavenger in an amount of 1% to 70% by weight, preferably 15% to 60% by weight, even more preferably 25% to 45% by weight, of the total weight of the formulation.

In a particularly preferred embodiment, the formulation according to the disclosure comprises the scavenger in an amount of 40% by weight of the total weight of the formulation.

In a preferred embodiment of the formulation according to the disclosure, the scavenger is anthranilamide.

In another preferred embodiment of the formulation according to the disclosure, the scavenger is 6-amino-1,3-dimethyluracil.

In yet another preferred embodiment of the formulation according to the disclosure, the scavenger is aminoguanidine monohydrochloride.

In yet another preferred embodiment of the formulation according to the disclosure, the scavenger is a mixture of at least two scavengers selected from anthranilamide, 6-amino-1,3-dimethyluracil and aminoguanidine monohydrochloride

In a second aspect, the present disclosure relates to a method for preparing the formulation according to the disclosure, which comprises the steps of:
i) mixing a polyol, a polymeric plasticizer, and an aldehyde scavenger selected from the group consisting of anthranilamide, salicylamide, salicylanilide, o-phenylenediamine, 3,4-diaminobenzoic acid, 1,8-diaminonaphthalene, o-mercaptobenzamide, N-acetylglycinamide, malonamide, 3-mercapto-1,2-propanediol, 4-amino-3-hydroxybenzoic acid, 4,5-dihydroxy-2,7-naphthalenedisulfonic acid disodium salt, biuret, 2,3-diaminopyridine, 1,2-diaminoanthraquinone, dianilinoethane, allantoin, 2-aminobenzenesulfonamide, 2-amino-2-methyl-1,3-propanediol, 6-amino-1,3-dimethyluracil, 6-aminoisocytosine, 6-aminouracil, 6-amino-1-methyluracil, urea, arginine salts, cysteine salts, serine salts, glycine salts, aminoguanidine salts, aspartic acid, guanidine salts, hydrazine, p-toluenesulfonyl hydrazine, carbohydrazide, oxalyldihydrazide, adipic acid dihydrazide, succinyldihydrazide, tocopherol, resveratrol, p-aminobenzoic acid, 3,5-dihydroxybenzoic acid, 4-hydroxybenzoic acid, mannitol, sorbitol, 5-aminolevulinic acid, methyl anthranilate, m-xylenediamine, 1,2-diaminocyclohexane and mixtures thereof, until a homogeneous liquid dispersion is obtained;
ii) milling the homogeneous liquid dispersion of step i) until obtainment of an average size of the solid particles dispersed in the homogeneous liquid dispersion of less than 50 µm, preferably less than 30 µm, as measured by means of a grindometer according to the ASTM D1210-05 standard.

The mixing of step i) is carried out with means that are known to the person skilled in the art, such as for example a high-speed dispersion mixer, preferably at a speed comprised between 20 and 1000 rpm, more preferably between 50 and 600 rpm, even more preferably between 150 and 450 rpm, for a time preferably comprised between 5 and 10 minutes, preferably at ambient temperature, more preferably at a temperature comprised between 15° C. and 30° C.

The milling in step ii) improves the efficacy of the scavenger by virtue of an increase in the surface area of the dispersed particles of such compounds. Furthermore, reaching the desired granulometry ensures the wettability of the scavenger in the vehicle (polyol), the homogeneity of the dispersion and the stability thereof over time. By virtue of the step of milling it is possible to measure the liquid dispersion in the polyol system and establish the percentage of use (LDR%) with precision, with consequent control of the reduction of free aldehydes. Furthermore, a particle size that is too large can cause defects in the final polyurethane foam.

The above mentioned step of milling can be carried out with methods known to the person skilled in the art, of which non-limiting examples are represented by milling with three roll mills, or bead mills.

When the solid materials are milled in a fluid vehicle to reduce the size of the particles, a grindometer is used to check the particle size. The agglomerates are reduced by milling in order to produce smaller aggregates or primary particles. Measurement with the grindometer is a simple and rapid method of determining the presence of coarse particles and their approximate size. The milling is carried out while monitoring the size of the solid particles until the desired granulometry is obtained.

The average particle size in the homogeneous liquid dispersion obtained as a consequence of the step of mixing the components of the formulation of the disclosure is measured according to the ASTM D1210-05 standard; however, other equivalent methods of determining the average particle size that are known to the person skilled in the art can be used without departing from the scope of the method of the present disclosure.

Mixing and milling with mechanical means can generate heat due to shear, with the result that some forms of processing can be subject to heating up to 80° C., without compromising the characteristics of the product.

Finally, the present disclosure also relates to a method for preparing a polyurethane composition comprising the step of adding the liquid formulation according to any of the embodiments of the disclosure to the reagents of the polyurethane composition.

The formulation of the present disclosure is compatible with different polyols and isocyanates used in the process of synthesizing polyurethane. For example, polyethers, polyesters, polycaprolactams, polybutadienes, polysulfides, acryl polyols and others that are known to the person skilled in the art, can all be used as polyols. In the automobile industry polyethers and polyesters are particularly preferred. Isocyanates that are compatible with the formulation of the disclosure comprise, as non-limiting examples, toluene diisocyanate (TDI) and diphenylmethane diisocyanate (MDI).

The polyurethane polymeric compositions obtained using the method of the disclosure are surprisingly characterized by a reduced content of free aldehydes. In particular, a reduction from 5% to 95% in the content of free aldehydes with respect to polyurethane compositions obtained using the same polyols and isocyanates in the absence of the formulation of the disclosure is observed.

It should be understood that the characteristics of embodiments described with reference to an aspect of the present disclosure are to be considered valid also with reference to the other aspects of the disclosure described herein, even if they are not explicitly repeated.

The disclosure will now be described with reference to the following non-limiting examples.

The following list of polyols was used: polyols for polyurethane integral skin (Specflex™ NR 784, LE SW System A.3.D.36.2.1/125), conventional polyol for Slabstock polyurethane-ether (Alcupol®F-4811), polyol for Slabstock polyurethane-ester (Desmophen®2200 B), polyol for Slabstock polyurethane-ether HR (Alcupol®P4181), polyol for visco-elastic Slabstock polyurethane foam (Lupranol® 2012).

### Example 1: Preparation of Formulations According to the Disclosure

Seven different formulations (F1-F7) were prepared in a 500 ml beaker, by adding polypropylene glycol, the polymeric plasticizer and the scavengers in the amounts indicated in Table 1.

The components of the formulation were then mixed using a dispersion mixer (ALCW180-E2, MAVER Milano Srl) at 300 rpm for 10 minutes until a homogeneous liquid dispersion was obtained.

The dispersion was processed in a three roll mill (Z1A, MOLTENI) until an average size of the solid particles dispersed in the homogeneous liquid dispersion of less than 30 µm was obtained, as determined by means of a grindometer according to the ASTM D1210-05 standard.

TABLE 1

| | | | | | | | |
|---|---|---|---|---|---|---|---|
| | F1 | F2 | F3 | F4 | F5 | F6 | F7 |
| PPG | 73.2 g | 73.2 g | 61.4 g | 73.2 g | 73.2 g | 73.2 g | 73.2 g |
| Plaxter P54 | 47.6 g | 47.6 g | 39.6 g | 47.6 g | 47.6 g | 47.6 g | 47.6 g |
| AA | 79.2 g | - | 49.6 g | - | 39.6 g | - | - |
| AG-HCl | - | - | 49.4 g | 79.2 g | 39.6 g | 39.6 g | - |
| 6-ADMU | - | 79.2 g | - | - | - | 39.6 g | 39.6 g |
| CI | - | - | - | - | - | - | 39.6 g |

PPG = polypropylene glycol
AA = anthranilamide
AG-HCl = aminoguanidine hydrochloride
6-ADMU = 6-amino-1,3-dimethyluracil
CI = carbohydrazide

### Example 2: Preparation of Polyurethane Polymeric Compositions

Six different polyurethane compositions were prepared by weighing, in a 100 ml beaker, 40 g of integral formulated polyol Specflex™ NR 784 (Dow) and, respectively, 0.4 g of the liquid formulations F1, F2, F4, F5, F6 and F7 according to the disclosure (1% by weight with respect to the polyol) to which 20 g of isocyanate Specflex™ NE117 were added. The mixture was left to react in free foam, i.e. without using a mold, allowing the foam to grow freely in an open system for 30 minutes at ambient temperature.

### Example 3: Preparation of Polyurethane Polymeric Compositions

Three different polyurethane foams were prepared by weighting in a 100 ml becher 40 g of polyol LE SW System A.3.D.36.2.1/125 (BASF) and, respectively, 0.4 g of liquid dispersions F2, F6 and F7 in accordance with this disclosure (1% in weight respect to the polyol) to whom 27.6 g of isocyanate ISO 134/16 were added. The mixture was left to react in free foam, i.e. without using a mold, allowing the foam to grow freely in an open system for 30 minutes at ambient temperature.

### Example 4: Quantification of the Free Aldehydes in The Polyurethane Polymeric Compositions Prepared in Example 2 and 3.

The foams obtained in examples 2 and 3 were cut in half, for subsequent quantification, respectively, of formaldehyde and of acetaldehyde, and from each one 100 mg were taken (in small fragments) which were then promptly inserted in a head space vial.

For the quantitative determination of formaldehyde, a derivatization was carried out by adding 15 microliters of a solution of pentafluorobenzyl hydroxylamine (PFBHA) (33.2 mg/mL in water) to the head space vials.

The calibration curve was also constructed by first derivatizing the formaldehyde, which otherwise is difficult to manipulate owing to its volatility, and difficult to separate using chromatography.

By contrast, acetaldehyde quantification was carried out using a calibration line that was constructed with standard solutions of acetaldehyde at different concentrations without requiring derivatization.

For each one of the six polyurethane foams produced respectively with the formulations F1, F2, F4-F7, the measurements of formaldehyde and of acetaldehyde were carried out in triplicate, thus obtaining six samples to be analyzed for each formulation.

### HS-GC-MS Analysis

The analyses of the formulations were carried out using the head space (HS) technique on a gas chromatograph/mass spectrometer (GC-MS) Perkin Elmer Clarus SQ 8 equipped with an Elite-5MS column (60 m × 0.25 mm × 1.0 µm).

The analyses were carried out using the parameters given in Table 2.

TABLE 2

| | |
|---|---|
| oven | 35° C. for 5 min, then 6° C./min to 245° C. |
| injector | 180° C., split 3 ml/min |
| inert gas | helium at 1.5 ml/min (initial pressure 23 psi), HS mode ON |
| scan interval | 35 to 350 Daltons |
| scan time | 0.1 s |
| interval between scans | 0.06 s |
| temperature of the source | 180° C. |
| temperature of the injector | 200° C. |
| run time | 40 min |

Injection into the GC-MS was achieved using a transfer line from the TurboMatrix 40 HS head space system. The HS (head space) conditions are described in Table 3.

TABLE 3

| | |
|---|---|
| vial equilibration | 150° C. for 30 minutes |
| needle | 160° C. |
| transfer line | 170° C., 0.25 mm I.D. fused silica |
| inert gas | helium at 45 psi |
| injection time | 0.08 min |
| vial | standard 22-ml vial with aluminum crimped cap with PTFE lined silicone septum |
| sample | 100 mg of polyurethane foam pieces |

The data were processed using the TurboMass v6.1.0 software.

The quantification of formaldehyde and acetaldehyde was obtained using calibration curves.

### Results for Example 2

Formulations 1, 2 and 4 and formulations 5 and 7 were respectively tested in three experiments the results of which are summarized respectively in Tables 4-6.

LDR% is the percentage amount of liquid formulation according to the disclosure (i.e. Formulation 1, 2, 4, 5, 6 and 7) with respect to the polyol.

AcA is the amount of acetaldehyde, while FA is formaldehyde. “Comp.” is the comparative sample of a polyurethane foam prepared without the use of a formulation according to the disclosure.

TABLE 4

| sample | scavenger | LDR % | average AcA (ppm) | AcA% reduction | average FA (ppm) | FA% reduction |
|---|---|---|---|---|---|---|
| Comp. | - | - | 107.3 | - | 157.0 | |
| 1 | AA | 1 | 82.1 | 23.5 | 131.6 | 16.2 |
| 2 | 6-ADMU | 1 | 72.4 | 32.5 | 77.4 | 50.7 |
| 4 | AG-HCl | 1 | 45.1 | 58.0 | 47.6 | 70.0 |

TABLE 5

| sample | scavenger | LDR % | average AcA (ppm) | AcA% reduction | average FA (ppm) | FA% reduction |
|---|---|---|---|---|---|---|
| Comp. | - | - | 115.7 | - | 138.6 | |
| 5 | AG-HCl/AA | 1 | 80.8 | 30.2 | 118.8 | 14.3 |
| 6 | AG-HCl/6- ADMU | 1 | 76.5 | 33.9 | 75.6 | 45.5 |

TABLE 6

| sample | scavenger | LDR % | average AcA (ppm) | AcA% reduction | average FA (ppm) | FA% reduction |
|---|---|---|---|---|---|---|
| Comp. | - | - | 79.5.7 | - | 229.4 | - |
| 7 | AG-HCl/AA | 1 | 35.2 | 55.7 | 57.1 | 75.1 |

The data show a reduction of 23.5% to 58% in the amount of free acetaldehyde and of 14.3% to 75.1% in the amount of free formaldehyde for the polymeric compositions produced with the addition of formulations according to the disclosure.

### Results for Example 3

Formulations 2, 6 and 7 were respectively tested in an experiment the results of which are summarized in Table 7.

LDR% is the percentage amount of liquid formulation according to the disclosure (i.e. Formulation 2, 6, and 7) with respect to the polyol.

AcA is the amount of acetaldehyde, while FA is formaldehyde. “Comp.” is the comparative sample of a polyurethane foam prepared without the use of a formulation according to the disclosure.

TABLE 7

| sample | scavenger | LDR % | average AcA (ppm) | AcA% reduction | average FA (ppm) | FA% reduction |
|---|---|---|---|---|---|---|
| Comp. | - | - | 8.4 | - | 368.9 | |
| 2 | 6-ADMU | 1 | 5.9 | 29.8 | 170.7 | 53.7 |
| 6 | AG-HCl/6- ADMU | 1 | 5.1 | 39.3 | 135.0 | 63.4 |
| 7 | CI/6DMU | 1 | 5.3 | 36.9 | 156.4 | 57.6 |

The data show a reduction of 29.8% to 39.3% in the amount of free acetaldehyde and of 53.7% to 63.4% in the amount of free formaldehyde for the polymeric compositions produced with the addition of formulations according to the disclosure.

### Example 5: Evaluation of the Effect of LDR% on the Presence Of Free Acetaldehyde.

In order to evaluate the effect of using different percentage amounts of liquid formulation according to the disclosure with respect to the polyol on the content of free aldehydes in the polyurethane, five polyurethane compositions were prepared by following the method described in example 2, according to the amounts given in Table 8.

TABLE 8

| sample | scavenger | LDR% | average AcA (ppm) | AcA% reduction |
|---|---|---|---|---|
| Comparative | | - | 91.9 | - |
| 1 | AA | 5 | 66.2 | 28.0 |
| 1 | AA | 10 | 45.9 | 50.1 |
| 2 | 6-ADMU | 5 | 48.3 | 47.4 |
| 2 | 6-ADMU | 10 | 41.9 | 54.4 |
| 3 | AA +AG-HCl | 5 | 15.7 | 82.9 |

The data in Table 8 show that according to the scavenger used, there is an effect of reduction of the presence of free acetaldehyde in the polyurethane which depends on the percentage amount of liquid formulation according to the disclosure with respect to the polyol in the reaction mixture.

### Example 6: Preparation of Polyurethane Foams (Conventional Slabstock Polyurethane-Ether)

Three different polyurethane foams were prepared by mixing 100 g of a polyether polyol (Alcupol® F-4811, MW = 3500, OH# =48), 2.3 g of water, 0.25 g of a tertiary amine catalyst (Niax™ B-4), 0.80 g of a silicone surfactant (Niax™ 620 LV) and, respectively, 1 g of liquid dispersions, F3, F6 and F7 in accordance with this disclosure (1% in weight respect the polyol) and 0.16 g of stannous octoate (Dabco® T-9) to whom 32.6 g of isocyanate (TDI 80/20 2,4/2,6 isomer blend of toluene diisocyanate) were added.

The mixture was left to react in free foam, i.e. without using a mold, allowing the foam to grow freely in an open system for for at least 16h. at ambient temperature.

3 A foam with a density of 40 kg/m was obtained.

### Example 7: Preparation of Polyurethane Foams (Slabstock Polyurethane-Ester)

Three different polyurethane foams were prepared by mixing 100 g of a polyester polyol (Desmophen® 2200 B, MW = 2000, OH# =57-63), 3.3 g of water, 0.4 g of a tertiary amine catalyst (Catalyst DMP), 1.8 g of a silicone surfactant (Niax® L-539) and, respectively, 1 g of liquid dispersions, F2, F6 and F7 in accordance with this disclosure (1% in weight respect the polyol) to whom 46.15 g of isocyanate (TDI 80/20 2,4/2,6 isomer blend of toluene diisocyanate) were added.

The mixture was left to react in free foam, i.e. without using a mold, allowing the foam to grow freely in an open system for for at least 16h. at ambient temperature.

3 A foam with a density of 30 kg/m was obtained.

### Example 8: Preparation of Polyurethane Foams (Slabstock Polyurethane-Ether HR)

Three different polyurethane foams were prepared by mixing 100 g of a grafted polyether polyol (Alcupol® P4181, MW = 3500, OH# = 42.5), 4.8 g of water, 0.33 g of a tertiary amine catalyst (Dabco® 33 LV), 1.10 g of a silicone surfactant (Dabco® DC 198) and, respectively, 1 g of liquid dispersions, F2, F6 and F7 in accordance with this disclosure (1% in weight respect the polyol) and 0.46 g of stannous octoate (Dabco® T-9) to whom 57.7 g of isocyanate (TDI 80/20 2,4/2,6 isomer blend of toluene diisocyanate) were added.

The mixture was left to react in free foam, i.e. without using a mold, allowing the foam to grow freely in an open system for for at least 16h. at ambient temperature.

3 A foam with a density of 25 kg/m was obtained.

### Example 9: Preparation of Polyurethane Foams (Visco-Elastic Slabstock Polyurethane Foam)

Three different polyurethane foams were prepared by mixing 15 g of a polyether polyol (Alcupol® F-4811, MW = 3500, OH# =48), 85 g of polyol blend (Lupranol 2012,OH# =53), 5 g diethanol amine, 0.15 g of triethylenediamine (TEDA-33), 0.3 g of a non-emissive amine catalyst (Dabco® NE300), 0.65 g of a silicone surfactant (Dabco®DC 198), 2.65 g of water and, respectively, 1 g of liquid dispersions, F3, F6 and F7 in accordance with this disclosure (1% in weight respect the polyol) to whom 57.7 g of isocyanate (MDI modified isomer blend of diphenylmethane diisocyanate, 32.3% NCO) were added.

The mixture was left to react in free foam, i.e. without using a mold, allowing the foam to grow freely in an open system for for at least 16h. at ambient temperature.

3 A foam with a density of 48 kg/m was obtained.

### Example 10: Determination of Aldehydes in Polyurethane Foam Prepared in Examples 6-9

The polyurethane foams were cut into cubic (12×12×12 cm) samples, which were packaged tightly in aluminum foil and stored at room temperature.

Aldehydes concentration were measured by using a custom-made stainless steel chamber (21×21×26 cm) equipped with two valves.

A polyurethane sample was placed inside the chamber that was then closed and heated for 2 h in an oven at 80° C.

Then air supply was connected to the inlet of the chamber while a cartridge (Supelco® LpDNPH S10) containing silica gel coated with 2,4-dinitrophenylhydrazine reagent was connected to the outlet.

A constant air flow rate was maintained through the chamber for 1 h while the aldehydes were collected on the DNPH column.

After sampling, the cartridges were stored at 4° C.

Each cartridge was then eluted with acetonitrile into a 5 mL volumetric flask at an elution rate of about 1 ml/min.

The resulting acetonitrile solution was analyzed by HPLC to quantify the aldehydes.

Calibration curves of formaldehyde and acetaldehyde (in the form of DNPH derivatives) were obtained by using standards at various concentrations (µg/ml).

Background levels were determined by eluting an unused DNPH cartridge. The blank values were subtracted from the analytical results.

### HPLC Analyses

Analyses were carried out by using a Perkin Elmer Series 200 HPLC instrument equipped with a PRONTOSIL KROMAPLUS 100 C18 column (5 µm, 250 mm × 4.6 mm).

Operating conditions for high performance liquid chromatography are collected in Table 9.

TABLE 9

| | |
|---|---|
| Detector | UV 360 nm |
| Column temperature | Room temperature |
| Flow rate | 1.0 ml/min |
| Injection volume | 20 µl |
| Mobile phase | Eluent A: water |
| | Eluent B: acetonitrile |
| Gradient program | Linear gradient from 45%B to 70%B over 30 min, linear gradient to 45%B over 5 min |
| Equilibration time | 3 min |

### Results

Formulations 1, 2, 3, 6 and 7 were tested in four experiments whose results are collected in Tables 10-13.

LDR% is the percentage amount of liquid formulation according to the disclosure (i.e. Formulation 2, 6, and 7) with respect to the polyol.

AcA is the amount of acetaldehyde, while FA is formaldehyde. “Comp.” is the comparative sample of a polyurethane foam prepared without the use of a formulation according to the disclosure.

TABLE 10

Example 6

| Sample | scavenger | LDR % | AcA | AcA | FA | FA |
|---|---|---|---|---|---|---|
| | | | 3 (µg/m /Kg) | reduction% | 3 (µg/m /Kg) | reduction% |
| Comp. | - | - | 152.0 | - | 156.0 | - |
| 3 | AA/AG-HCl | 1 | 123.3 | 18.8 | 102.0 | 34.6 |
| 6 | AG-HCl/6-ADMU | 1 | 99.4 | 34.6 | 65.5 | 58.0 |
| 7 | CI/6DMU | 1 | 57.3 | 62.3 | 59.3 | 62.0 |

TABLE 11

Example 7

| Sample | scavenger | LDR % | AcA | AcA | FA | FA |
|---|---|---|---|---|---|---|
| | | | 3 (µg/m /Kg ) | reduction% | 3 (µg/m /Kg) | reduction% |
| Comp. | - | - | 58.4 | - | 137.1 | - |
| 1 | AA | 1 | 22.1 | 62.2 | 57.3 | 58.2 |
| 2 | 6-ADMU | 1 | 35.4 | 39.4 | 52.4 | 61.8 |
| 3 | AG-HCl/6-ADMU | 1 | 15.6 | 73.3 | 49.4 | 87.7 |

TABLE 12

Example 8

| Sample | scavenger | LDR % | AcA | AcA | FA | FA |
|---|---|---|---|---|---|---|
| | | | 3 (µg/m /Kg) | reduction% | 3 (µg/m /Kg) | reduction% |
| Comp. | - | - | 38.5 | - | 81.7 | - |
| 2 | 6-ADMU | 1 | 30.4 | 21.4 | 40.2 | 50.2 |
| 6 | AG-HCl/6-ADMU | 1 | 15.2 | 60.5 | 29.4 | 64.0 |
| 7 | CI/6DMU | 1 | 18.8 | 51.2 | 32.7 | 60.0 |

TABLE 13

Example 9

| Sample | scavenger | LDR % | AcA | AcA | FA | FA |
|---|---|---|---|---|---|---|
| | | | 3 (µg/m /Kg) | reduction% | 3 (µg/m /Kg) | reduction% |
| Comp. | - | - | 52 | - | 99 | - |
| 3 | AA/AG-HCl | 1 | 44 | 15.4 | 59.6 | 39.8 |
| 6 | AG-HCl/6-ADMU | 1 | 23.5 | 54.9 | 46.0 | 53.5 |
| 7 | CI/6DMU | 1 | 26.6 | 48.8 | 29.3 | 70.4 |

The data show a reduction of 15.4% to 73.3% in the amount of free acetaldehyde and of 34.6% to 87.7% in the amount of free formaldehyde for the polymeric compositions produced with the addition of formulations according to the disclosure.

In practice it has been found that the formulation according to the disclosure fully achieves the set aim, in that it makes it possible to obtain a considerable reduction of the content of acetaldehyde and of formaldehyde in polyurethane polymeric compositions.

The formulation of the present disclosure, the method for its preparation and the method for preparing a polyurethane composition are susceptible of numerous modifications and variations, all of which are within the scope of the appended claims. Moreover, all the details may be substituted by other, technically equivalent elements, the correspondence of which is known to the person skilled in the art.

The disclosures in Italian Patent Application No. 102020000012334 from which this application claims priority are incorporated herein by reference.

1-10. (canceled)

11. A liquid formulation for reducing free aldehydes levels in a polyurethane composition, said formulation comprising: a polyol, a polymeric plasticizer, and an aldehyde scavenger selected from the group consisting of anthranilamide, salicylamide, salicylanilide, o-phenylenediamine, 3,4-diaminobenzoic acid, 1,8-diaminonaphthalene, o-mercaptobenzamide, N-acetylglycinamide, malonamide, 3-mercapto-1,2-propanediol, 4-amino-3-hydroxybenzoic acid, 4,5-dihydroxy-2,7-naphthalenedisulfonic acid disodium salt, biuret, 2,3-diaminopyridine, 1,2-diaminoanthraquinone, dianilinoethane, allantoin, 2-aminobenzenesulfonamide, 2-amino-2-methyl-1,3-propanediol, 6-amino-1,3-dimethyluracil, 6-aminoisocytosine, 6-aminouracil, 6-amino-1-methyluracil, urea, arginine salts, cysteine salts, serine salts, glycine salts, aminoguanidine salts, aspartic acid, guanidine salts, hydrazine, p-toluenesulfonyl hydrazine, carbohydrazide, oxalyldihydrazide, adipic acid dihydrazide, succinyldihydrazide, tocopherol, resveratrol, p-aminobenzoic acid, 3,5-dihydroxybenzoic acid, 4-hydroxybenzoic acid, mannitol, sorbitol, 5-aminolevulinic acid, methyl anthranilate, m-xylenediamine, 1,2-diaminocyclohexane and mixtures thereof.

12. The liquid formulation according to claim 11, wherein the polyol is polypropylene glycol.

13. The liquid formulation according to claim 11, wherein the polyol is in an amount of 10% to 70% by weight, of the total weight of the formulation.

14. The liquid formulation according to claim 11, wherein the polymeric plasticizer is in an amount of 10% to 60% by weight, of the total weight of the formulation.

15. The liquid formulation according to claim 11, wherein the aldehyde scavenger is in an amount of 1% to 70% by weight, of the total weight of the formulation.

16. The liquid formulation according to claim 11, wherein the weight ratio between the polyol and the polymeric plasticizer is comprised between 80:20 and 50:50.

17. The liquid formulation according to claim 11, wherein said polymeric plasticizer is an ester of adipic acid.

18. The liquid formulation according to claim 11, wherein said aldehyde scavenger is selected from the group consisting of anthranilamide, 6-amino-1,3-dimethyluracil, and aminoguanidine monohydrochloride.

19. A method for preparing a liquid formulation according to claim 11, the method including the following steps:
i) mixing a polyol, a polymeric plasticizer, and an aldehyde scavenger selected from the group consisting of anthranilamide, salicylamide, salicylanilide, o-phenylenediamine, 3,4-diaminobenzoic acid, 1,8-diaminonaphthalene, o-mercaptobenzamide, N-acetylglycinamide, malonamide, 3-mercapto-1,2-propanediol, 4-amino-3-hydroxybenzoic acid, 4,5-dihydroxy-2,7-naphthalenedisulfonic acid disodium salt, biuret, 2,3-diaminopyridine, 1,2-diaminoanthraquinone, dianilinoethane, allantoin, 2-aminobenzenesulfonamide, 2-amino-2-methyl-1,3-propanediol, 6-amino-1,3-dimethyluracil, 6-aminoisocytosine, 6-aminouracil, 6-amino-1-methyluracil, urea, arginine salts, cysteine salts, serine salts, glycine salts, aminoguanidine salts, aspartic acid, guanidine salts, hydrazine, p-toluenesulfonyl hydrazine, carbohydrazide, oxalyldihydrazide, adipic acid dihydrazide, succinyldihydrazide, tocopherol, resveratrol, p-aminobenzoic acid, 3,5-dihydroxybenzoic acid, 4-hydroxybenzoic acid, mannitol, sorbitol, 5-aminolevulinic acid, methyl anthranilate, m-xylenediamine, 1,2-diaminocyclohexane and mixtures thereof, until a homogeneous liquid dispersion is obtained;
ii) milling the homogeneous liquid dispersion of step i) until obtainment of an average size of solid particles dispersed in the homogeneous liquid dispersion of less than 50 µm, as measured by means of a grindometer according to the ASTM D1210-05 standard.

20. A method for preparing a polyurethane composition comprising the step of adding a liquid formulation according to claim 11, to reagents of the polyurethane composition.
